(19) United States
(12) Patent Application Publication
(10) Pub. No.: US 2026/0212161 A1
(43) Pub. Date: Jul. 23, 2026

(54) IDENTIFYING SEQUENCES OF MACHINE LEARNING MODELS

(71) Applicant: Telefonaktiebolaget LM Ericsson (publ), Stockholm (SE)

(72) Inventors: Sumit SOMAN, Noida (IN); Sunil Kumar VUPPALA, Mahadevapura, Bangalore (IN)

(73) Assignee: Telefonaktiebolaget LM Ericsson (publ), Stockholm (SE)

(21) Appl. No.: 19/144,171

(22) PCT Filed: Jan. 4, 2023
(86) PCT No.: PCT/IN2023/050008

§ 371 Date: Jun. 27, 2025

(51) Int. Cl. G06N 3/0455; G06N 3/0475; G06N 20/10

(52) U.S. Cl. CPC G06N 3/0455; G06N 3/0475; G06N 20/10

(57) ABSTRACT

A computer-implemented method of identifying sequences of machine learning (ML) models of a plurality of ML models during a training phase is provided. The method comprises generating one or more sequences of the ML models The method further comprises determining a performance of each sequence of the ML models. Furthermore, the method comprises identifying a sequence with performance greater than a threshold performance.

### TECHNICAL FIELD

The invention relates to a computer-implemented method of identifying sequences of machine learning (ML) models of a plurality of ML models during a training phase, a corresponding computing device, a corresponding computer program, a corresponding computer-readable data carrier, and a corresponding data carrier signal.

### BACKGROUND

Artificial intelligence and machine learning (ML) algorithms have been developed to solve problems that may be difficult or impossible to solve through conventional computer programming. For example, it may not be possible for a software engineer to determine a set of instructions and rules for anomaly detection or root cause analysis in telecommunication networks, or for network optimization. However, ML algorithms can solve such problems by building ML models that are trained on a set of training data. These ML models may identify patterns within the training data that may be difficult for human software engineers recognize, and that can be used for classifying data, organizing data, optimization, and making predictions or decisions.

One constraint on ML algorithms is that the ML models they generate can only perform as well as the training data that they are based on. In addition, different ML algorithms have different strengths, weaknesses, and biases, which may lead to poor model performance in certain circumstances. For example, ML models may be trained on a dataset repository 101 comprising multiple datasets for multiple tasks as illustrated in FIG. 1. An ML task for an ML model represents a purpose for which the ML model may be initially trained using a dataset. In this setting, ML models may be trained independently on different tasks using one or more datasets. These tasks may correspond to various use cases, such as Key Performance Indicator (KPI) prediction, estimation of cell-tower location, among others. Each of these tasks may include multiple sub-tasks. For example, KPI prediction may include throughput and latency estimation. ML models in the telecom domain are typically built as silos and adopt a task-specific or data-specific approach.

There have been some attempts to realize ML tasks using multiple ML models. For example, Google discusses pathways for ML where a single ML model may generalize multiple tasks to understand different types of data (see, e.g., https://blog.google/technology/ai/introducing-pathways-next-generation-ai-architecture/, captured on Dec. 9, 2022). In another example, the use of multiple ML models for functionalities with binary indicator variables is disclosed (see, e.g., “OrchestRAN: Network Automation through Orchestrated Intelligence in the Open RAN” by Salvatore D'Oro, Leonardo Bonati, Michele Polese, and Tommaso Melodia, in Proc. of IEEE INFOCOM 2022, pages 270-279, doi.org/10.1109/INFOCOM48880.2022.9796744).

There is an opportunity to discover new tasks based on combinations of ML models.

### SUMMARY

It is an object of the invention to provide an improved alternative to the above techniques and prior art.

More specifically, it is an object of the invention to identify sequences of machine learning (ML) models of a plurality of ML models during a training phase.

These and other objects of the invention are achieved by means of different aspects of the invention, as defined by the independent claims. Embodiments of the invention are characterized by the dependent claims.

According to a first aspect of the invention, a computer-implemented method of identifying sequences of ML models of a plurality of ML models during a training phase is provided. The method comprises generating one or more sequences of the ML models. The method further comprises determining a performance of each sequence of the ML models. Furthermore, the method comprises identifying a sequence with performance greater than a threshold performance.

According to a second aspect of the invention, a computing device for identifying sequences of ML models of a plurality of ML models during a training phase is provided. The computing device comprises a processing circuitry operative to generate one or more sequences of the ML models. The processing circuitry is further operative to determine a performance of each sequence of the ML models. Furthermore, the processing circuitry is operative to identify a sequence with performance greater than a threshold performance.

According to a third aspect of the invention, a computer program is provided. The computer program comprises instructions which, when the computer program is executed by a computer, cause the computer to carry out the method of an embodiment of the first aspect of the invention.

According to a fourth aspect of the invention, a computer-readable data carrier is provided. The computer-readable data carrier has stored thereon the computer program of the third aspect of the invention.

According to a fifth aspect of the invention, a data carrier signal is provided. The data carrier signal carries the computer program of the third aspect of the invention.

Even though advantages of the invention have in some cases been described with reference to embodiments of the first aspect of the invention, corresponding reasoning applies to embodiments of other aspects of the invention.

Further objectives of, features of, and advantages with, the invention will become apparent when studying the following detailed disclosure, the drawings and the appended claims. Those skilled in the art realize that different features of the invention can be combined to create embodiments other than those described in the following.

### BRIEF DESCRIPTION OF THE DRAWINGS

The above, as well as additional objects, features and advantages of the invention, will be better understood through the following illustrative and non-limiting detailed description of embodiments of the invention, with reference to the appended drawings, in which:

FIG. 1 illustrates training machine learning (ML) models on multiple datasets for multiple ML tasks, as is known in the art.

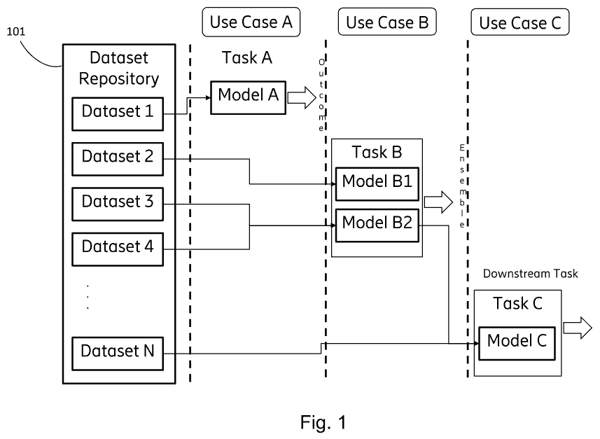

FIG. 2 schematically illustrates a computing device for identifying sequences of ML models of a plurality of ML models, in accordance with embodiments of the invention.

FIG. 3 shows a flow chart illustrating a method of identifying sequences of ML models of a plurality of ML models, in accordance with embodiments of the invention.

FIG. 4 schematically illustrates identifying sequences of ML models of a plurality of ML models, in accordance with embodiments of the invention.

FIG. 5 schematically illustrates discovering new ML tasks from sequences of ML models with performance greater than a threshold performance, in accordance with embodiments of the invention.

FIG. 6 schematically illustrates a neural network, in accordance with embodiments of the invention.

FIG. 7 illustrates a directed acyclic graph comprising a sequence of ML models each of which has been trained on different datasets from a data lake for different ML tasks, in accordance with embodiments of the invention.

FIG. 8 schematically illustrates outputting data from a preceding ML model in the sequence and using the data as input to a subsequent ML model in the sequence, in accordance with embodiments of the invention.

FIG. 9 exemplarily illustrates a sequence of ML models each of which has been trained on different datasets, in accordance with an embodiment of the invention.

All the figures are schematic, not necessarily to scale, and generally only show parts which are necessary in order to elucidate the invention, wherein other parts may be omitted or merely suggested.

### DETAILED DESCRIPTION

The invention will now be described more fully herein after with reference to the accompanying drawings, in which certain embodiments of the invention are shown. This invention may, however, be embodied in many different forms and should not be construed as limited to the embodiments set forth herein. Rather, these embodiments are provided by way of example so that this disclosure will be thorough and complete, and will fully convey the scope of the invention to those skilled in the art.

Machine learning refers to the use of artificial intelligence (AI) computer algorithms to build predictive models that may learn and improve through experience. An AI algorithm may include an algorithm that is associated with tasks that normally require human intelligence. Examples of tasks associated with artificial intelligence algorithms may include network optimization, anomaly detection, traffic balancing, radio capacity planning, throughput degradation, etc.

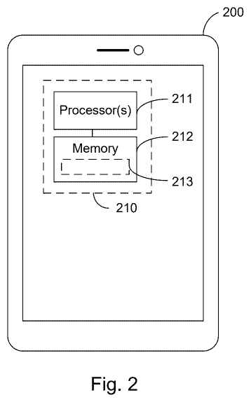

FIG. 2 illustrates a computing device 200 for identifying sequences of machine learning (ML) models of a plurality of ML models during a training phase, in accordance with embodiments of the invention. The computing device 200 may, e.g., be a smartphone, a tablet computer, a laptop, a desktop computer, an infotainment system for a car, or the like. Each of the plurality of ML models may, for example, be a neural network, an autoencoder, a generative adversarial network (GAN) model, a long short term memory (LSTM) model, a gated recurrent unit 15 (GRU) a support vector machine (SVM) a decision tree, a random forest, or a deep learning model.

An ML model is created using an ML algorithm. The ML algorithm may be used to identify patterns, make decisions, or make predications. For example, classifications may be generated by applying input data, whose class label is unknown to a classification model. A clustering algorithm is another example of an ML algorithm. A predictive model may be trained using training data, such that the model may be used to make predictions.

Further with reference to FIG. 2, the computing device 200 for identifying sequences of ML models comprises processing circuitry 210. The processing circuitry 210 may comprise one or more processors 211, such as Central Processing Units (CPUs), microprocessors, application processors, application-specific processors, Graphics Processing Units (GPUs), and Digital Signal Processors (DSPs) including image processors, or a combination thereof, and a memory 212 comprising a computer program 213 comprising instructions. When executed by the processor(s) 211, the instructions cause the computing device 200 to become operative in accordance with embodiments of the invention described herein. The memory 212 may, e.g., be a Random-Access Memory (RAM), a Read-Only Memory (ROM), a Flash memory, or the like. The computer program 213 may be downloaded to the memory 212 by means of a network interface circuitry (not shown in FIG. 2), as a data carrier signal carrying the computer program 213. The network interface circuitry may comprise one or more of a cellular modem (e.g., GSM, UMTS, LTE, 5G, or higher generation), a WLAN/Wi-Fi modem, a Bluetooth modem, an Ethernet interface, an optical interface, or the like, for exchanging data between the computing device 200 and other computing devices, communications devices, a radio-access network, and/or the Internet. The processing circuitry 210 may alternatively or additionally comprise one or more Application-Specific Integrated Circuits (ASICs), Field-Programmable Gate Arrays (FPGAs), or the like, which are operative to cause the computing device 200 to become operative in accordance with embodiments of the invention described herein.

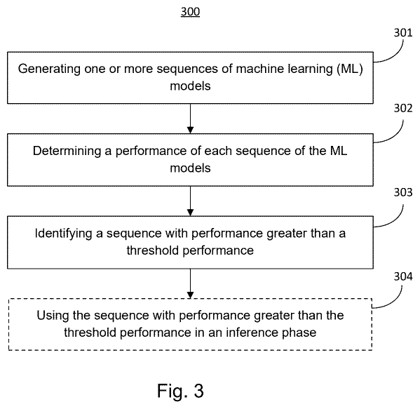

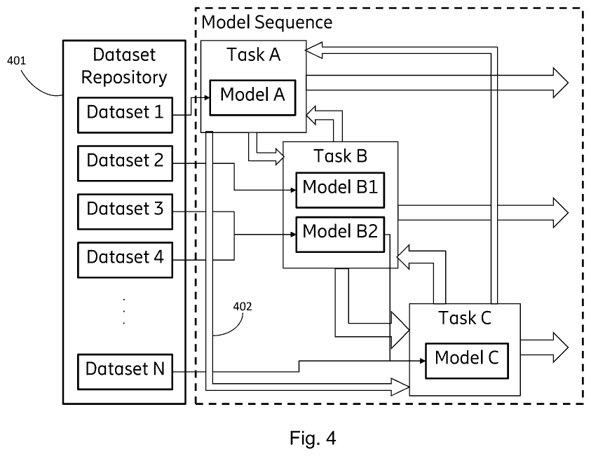

With reference to FIG. 3, embodiments of a computer-implemented method 300 of identifying sequences of ML models of a plurality of ML models during a training phase are described. The method 300 is performed by a computing device 200 and comprises generating 301 one or more sequences of the ML models. The sequences of ML models comprise two or more of the plurality of ML models. The ML models in the sequence are compatible, such that a preceding ML model in the sequence outputs data which is used as input to a subsequent ML model in the sequence. The data may be readable by the ML models. Identifying sequences of ML models of a plurality of ML models, in accordance with embodiments of the invention, is exemplarily illustrated in FIG. 4.

With reference to FIG. 4, two ML models, ML model A and ML model C, form a sequence 402. The ML models in the sequence 402 may be trained on one or more datasets for performing different ML tasks. An ML task for an ML model represents a purpose for which the ML model may be initially trained using a dataset and subsequently used for achieving said purpose on data point(s). An ML task may, for example include root cause analysis, classification (such as predicting customer churn), regression (such as estimating energy consumption), clustering (such as customer segmentation) and time-series forecasting (such as KPI prediction for cells). Each of the datasets may be stored in a data repository 401. For the example illustrated in FIG. 4, the data repository 401 stores a plurality of datasets. A dataset contains separate pieces of data which may be used to train an algorithm with the goal of finding predictable patterns inside the whole dataset.

In some embodiments, one ML model may be trained on one dataset. In other embodiments, one ML model may be trained on multiple datasets. For example, these multiple datasets may comprise different types of data. A dataset may comprise data, such as street view images, while another dataset may comprise data such as cell identifiers with their respective locations. In yet other embodiments, one dataset may be used in training multiple ML models. For example, ML model A is trained on Dataset 1 for ML task A, whereas ML model B2 is trained on Dataset 3 and Dataset 4 for ML task B. In an embodiment, a preceding ML model in a sequence outputs data which is used as input to a subsequent ML model in the sequence. In an example, the data from an intermediate layer of a preceding ML model, such as ML model A, may be transferred to an intermediate layer of a subsequent ML model, such as ML model C, in the sequence 402. In another example, the data from an intermediate layer of a source ML model may be transferred to an input layer of a destination ML model. The preceding ML model and the subsequent ML model are compatible. The output data, e.g., data from an intermediate layer from the preceding ML model in a sequence is readable by the subsequent ML model, i.e., output data is in a format readable by the subsequent ML model. The output data is then used as input to the intermediate layer or the input layer of the subsequent ML model in the sequence. As a prerequisite during a model design phase, aspects pertaining to sharing of data between ML models or transferring data from intermediate representations are specified to ensure compatibility of models. This may exemplarily include the dimensionality of data to be generated and shared between the ML models. For example, if all models are neural networks, the dimensions of shared data may be specified as 512, in which case all ML modes will generate or consume data in 512 dimensions, by design.

In some embodiments, the ML models, ML model A, ML model B1, ML model B2, and ML model C, may, for example, each be any of a neural network, an autoencoder, a generative adversarial network (GAN) model, a long short term memory (LSTM) model, a gated recurrent unit (GRU) a support vector machine (SVM) a decision tree, a random forest, and a deep learning model.

The method 300 further comprises determining 302 a performance of each sequence of the ML models. In one embodiment, the performance of a sequence may be determined based on performance of the ML models in the sequence. As the dataset on which the ML models are trained evolves, i.e., when an ML model is trained on additional data, the ML model performance may be updated. Since the performance of each sequence of ML models is determined based on respective performances of the ML models in the sequence, the performance of the sequence is updated as well. The performance of each sequence of ML models may be a normalized value. Normalizing value of performance of a sequence involves applying one or more functions on the performance values of the ML models in the sequence so that they are constrained to be within a predefined upper and lower limit, such as for example, an upper limit of 1 and a lower limit of 0. The normalized value is representative of the magnitude of performance within the scale spanned by the upper and lower limits. The upper and lower limits of model performance may be determined by the type of ML model. For example, for a classification model, an upper and lower limit may be determined by accuracy, for a regression model, an upper and lower limit may be determined by mean squared error, etc.

The method 300 further comprises identifying 303 a sequence with performance greater than a threshold performance. For example, performance of a sequence may have initially been low due to low performance of the ML models in the sequence. This may be due to poor availability of data for training the ML models in datasets using which they are trained. The performance of a sequence of ML models is a normalized value based on the type of ML models in the sequence. The normalized performance values of the sequence are limited to a range, for example, between 0 and 1. For example, a least performing ML model may have a performance value of 0, while a best performing ML model may have a performance value of 1. In this example, a low performing sequence may be determined as a sequence with performance value lower than a predefined threshold performance, which may be presumed to be 0.5. However, as additional data becomes available in the datasets, it may be possible that the performance of the sequence that was earlier low may increase when being re-evaluated based on performance of the ML models in the sequence. For example, a high performing sequence has a performance value higher than a predefined threshold performance, for example, 0.9.

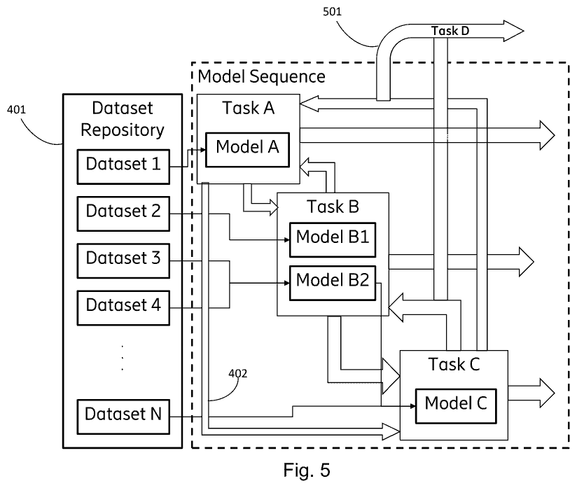

In an embodiment, the method 300 may comprise using 304 the sequence with performance greater than the threshold performance in an inference phase. For example, discovering new ML tasks from sequences of ML models with performance greater than a threshold performance, in accordance with embodiments of the invention, is illustrated in FIG. 5. In an example, the threshold performance for a sequence may be determined to be 0.9. When the sequence has a performance value higher than 0.9 it may be deemed to be a high performing sequence. The sequence with performance greater than the threshold performance of 0.9 may lead to discovery of a new ML task, ML task D 501. A high performing sequence may include high performing ML models, which causes higher transfer of data from intermediate representation of a preceding ML model in the sequence to an intermediate representation of the subsequent ML model in the sequence. The intermediate representations of both preceding ML model and the subsequent ML model are allowed to interact which causes generalization of the data for obtaining inferences from the data. The inferences thus obtained may be new ML tasks. New ML tasks are tasks for which no separate ML model has been trained but were discovered as a result of interaction between intermediate representations of high performing ML models.

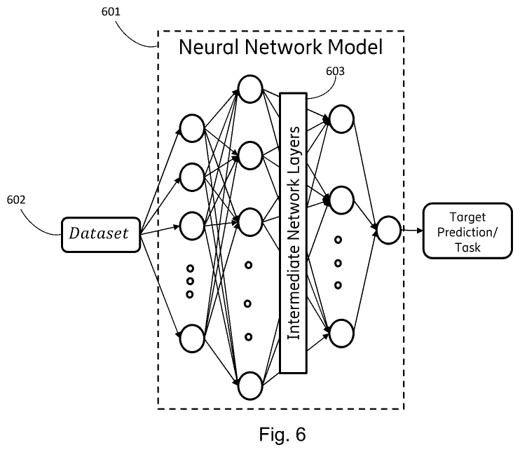

FIG. 6 schematically illustrates a neural network 601, in accordance with embodiments of the invention. As used herein, a neural network refers to an ML model that includes a model of interconnected artificial neurons (organized in layers) that communicate and learn to approximate complex functions and generate outputs based on a plurality of inputs provided to the model. The neural network 601 (as shown in FIG. 6) may have, for example, been trained for a specific predictive task using a dataset 602. The neural network 601 includes intermediate network layers 603, which include intermediate representations. An intermediate representation refers to a representation of data generated by an ML model which is subsequently used by the ML model or transferred to a subsequent ML model.

Training an ML model, such as a neural network 601, involves revising model weights by minimizing an error between a predicted value and an actual value of a target variable using a set of features from a dataset for a given ML task. This is, quite often, an iterative process which leads to finding an optimal set of weights that minimizes the error for the training dataset.

The performance of an ML model is validated using a validation dataset. The validation dataset is a sample of data held back from training the ML model that is used to evaluate performance of the ML model. As more data is available over time, the ML model may be retrained, which may affect the performance of the ML model. In an embodiment, the ML models are retrained as and when additional data becomes available. This affects the performance of the ML models and eventually the performance of the sequence of the ML models.

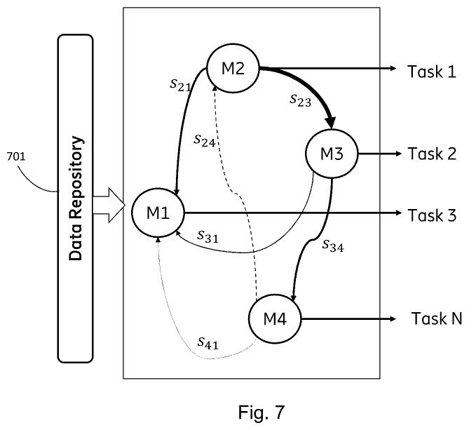

FIG. 7 exemplarily illustrates a directed acyclic graph comprising a sequence of ML models each of which have been trained on different datasets from a data repository 701 for different ML tasks, in accordance with embodiments of the invention. The sequences of ML models comprise, for example, M₁, M₂, M₃, and M₄. The ML models, M₁, M₂, M₃, and M₄, may have, for example, been trained for ML tasks, Task 1, Task 2, Task 3, and Task N, respectively. An ML model, such as M₂ may be in multiple sequences comprising other ML models, such as M₂ and M₁, and M₂ and M₃. The directed acyclic graph (also referred to as model graph) is induced by a set of n models M₁, 1≤i≤n and edges (connections), where sᵢⱼ represents the performance of a sequence comprising ML model i and ML model j. Each ML model may be trained on a multiplicity of datasets to obtain predictions on a multiplicity of T tasks. The performance value sᵢⱼ^{t} is normalized based on the ML models, ML model j and ML model i. ML model j which is a downstream model of ML model i (which in this example is a subsequent ML model, ML model j) is trained on a set of t tasks. A subsequent ML model, i.e., ML model j receives an intermediate representation output by a preceding ML model, i.e., ML model i as input, to obtain the final prediction on the ML task using the ML models jointly. The ML models, ML model i and ML model j are in the sequence. The ML models are compatible and the intermediate representation output by ML model i is in a format readable by ML model j. The output by ML model i is then used as input to the intermediate layer of ML model j. Higher performance of ML models in a sequence result in the sequence having a high performance. As disclosed earlier, a prerequisite during a model design phase involves specifying aspects pertaining to sharing of data between ML models or transferring data from intermediate representations, to ensure compatibility of models.

In order to determine performance of an ML model, we consider edges of the model graph. The edges of the model graph with performance values sᵢⱼ^{t} may be initialized, with small non-zero values for numerical stability, when the ML models have been trained on a first set of data samples. The performance sᵢⱼ^{t} of a sequence of ML models may be determined iteratively. The performance of an ML model at (n+1), where n denotes the iteration, where additional data is available for the model retraining using which, the weights are updated, may be computed using the following update rule:

$${s}_{ij}^{t} ( n + 1 ) = {s}_{ij}^{t} ( n ) + {α}^{t} \frac{{s}_{ij}^{t} ( n )}{{\sum }_{p = 1 , p \neq t}^{T} {s}_{ij}^{p} ( n )} - {β}^{t} {s}_{ij}^{t} ( n ) , subject to ,$$

$${\sum }_{t = 1}^{T} {s}_{ij}^{t} ( n ) = 1$$

Decrease in performance of the ML model by “dilution” is represented by β, whereas increase in performance of the ML model by “concentration” is represented by a. The decrease in performance of a sequence of ML models may be due to poor performance of the ML models in the sequence. The decrease in performance is penalized more heavily in comparison to rewarding an increase in performance. ML models in the model graph is initially trained for ML tasks, Task 1, Task 2, Task 3 and Task N. The computation of performance may be configured for a sequence of ML models based on whether there is a requirement to reinforce improvement in performance strongly or penalize deterioration in performance strongly. If the requirement is to reinforce improvement in performance strongly, “α” may be close to 1 and “β” may be close to 0. Alternatively, if the requirement is to penalize deterioration in performance strongly, “α” may be close to 0 and “β” may be close to 1. The factors α, β can be used to induce or delete edges in the model graph. In addition to existing tasks, the model graph may also be used for discovery of new ML tasks.

When the performance of ML models in a sequence increase, the performance of the sequence with the ML models may increase beyond a threshold performance, in the inference phase. During the inference phase, knowledge from a trained ML model is used to infer a result. For example, when new unknown data is input through a trained ML model, it may output a prediction that is limited to predictive accuracy of the ML model. When performance of the sequence with the ML models increases beyond a threshold performance, new ML tasks may be discovered.

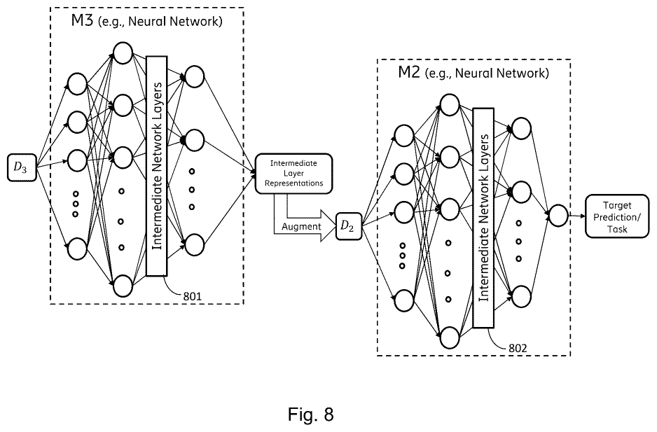

As described earlier, a preceding ML model in the sequence outputs data which is used as input to a subsequent ML model in the sequence. FIG. 8 schematically illustrates outputting data from the preceding ML model in the sequence and using the data as input in the subsequent ML model in the sequence, in accordance with embodiments of the invention. An intermediate representation refers to a representation of data generated by an ML model, comprising one or more items of data pertaining to the ML model and one or more design details attributed to the ML model for enabling the ML model to perform a required action.

Intermediate layer(s) is/are one or more layers between an input layer and an output layer of the neural network. Intermediate layer representations refer to data representations generated by intermediate representations. In case of a deep neural network, intermediate representations may, for example, refer to values of activation functions of neurons of a specific intermediate layer of the network, excluding the input layer and the output layer, which produces the model output. Intermediate layer representations may also refer to representations in latent or kernel spaces, in which data may have been projected by the models, such as, for example, in case of support vector machine (SVM) models. An output layer takes into consideration results from intermediate layers to produce the model output.

The ML model shown in FIG. 8, i.e., a neural network M3 (preceding ML model) is trained on a dataset D3 for an ML task. The neural network M3 comprises intermediate network layers 801. A neural network M2 (subsequent ML model) is trained on another dataset D2 for an ML task. The neural network M2 comprises intermediate network layers 802. In an embodiment, the intermediate layer data output from intermediate network layers 801 from the preceding ML model, i.e., the neural network M3, is used as input to intermediate network layers 802 of the subsequent ML model, i.e., the neural network M2. In another embodiment, the data from the intermediate network layers 801 is transferred to an input layer (not shown in FIG. 8) of the neural network M2. The input layer in the context of a neural network is composed of artificial input neurons and brings initial data for further processing by subsequent layers of artificial neurons. The input layer is a component of the artificial neural network. In addition to receiving data generated from an intermediate layer of the neural network M3, the neural network M2 receives its own training data, which further affects performance of the neural network M2.

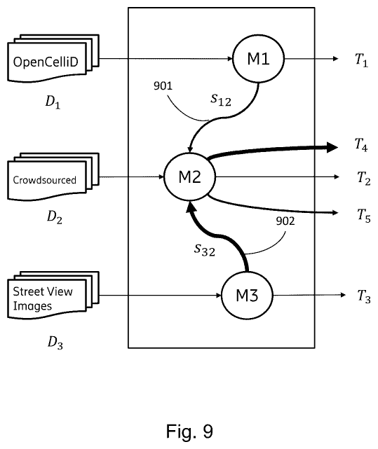

FIG. 9 exemplarily illustrates a sequence of ML models each of which has been trained on different datasets, in accordance with an embodiment of the invention. In this example, we consider a sequence 901 of ML models, M1 and M2 and a sequence 902 of ML models, M3 and M2. The ML model M1 computes weighted centroids and is trained for an ML task T1 which estimates cell-tower location. The ML model M1 may use a dataset D1 with cell identifiers with their respective locations, for example, from OpenCelliD. Another ML task, T2 may generate one or more cell coverage polygons which may use the ML model M2. The ML model M2 may perform a set of geo-spatial operations to generate the cell coverage polygons using a dataset D2 with User Equipment (UE) connection test data, that may, for example, be crowdsourced. Yet another ML task during network planning and design, task T3 may be antenna detection and may use the ML model M3. The ML model M3 may be a deep learning model such a Region based Convolutional Neural Network (R-CNN). The ML model M3 may use a dataset D3 of street view images to detect utility poles.

In this example, the ML model M1 and the ML model M2 are connected and the ML model M3 and the ML model M2 are connected. The ML model M1 and the ML model M3 in the sequence 901 output data which is used as input to the ML model M2. While the ML model M2 has its own training data (UE connection test data), the ML model M2 receives an intermediate layer representation generated by ML model M3 from the dataset D3 (street view images). The intermediate layer representation received from ML model M3 includes representation of street view images while the intermediate layer representation already with ML model M2 includes a representation of UE connection test data. When the intermediate representations of both ML model M2 and ML model M3 are allowed to interact, a generalization of the representation of street view images and the representation of UE connection test data takes place. This generalization results in obtaining inferences from the data. One such inference may be a new task by the ML model M2, i.e. generating the cell coverage polygons.

The performance of a sequence of the ML model M1 and the ML model M2 is represented by s₁₂, whereas the performance of a sequence between the ML model M3 and the ML model M2 is represented by s₃₂. The performance, s₁₂, may be normalized. In an example, edges of the model graph comprising the ML models M1 and M2 may be initialized with small non-zero values for numerical stability. As there is a change in performance values of the ML models M1 and M2, the performance of the sequence, s₁₂, may be updated. As new batches of training datasets D1 and D2 become available, the ML models M1 and M2 are retrained, and their performance values are updated. In essence, the performance, s₁₂, represents the performance of the sequence of ML models M1 and M2. If the performance, s₁₂, is greater than a predefined threshold performance, there may be new ML tasks that are discovered.

As more training data is available, the ML models in the sequence 901 are trained, and their performance may be affected. As a result of change in performance of the ML models M1, M2, and M3, the performance of the sequence 901 with ML models M1 and M2 and the sequence 902 with ML models M3 and M2, are updated. When the performance of each of the sequences, the sequence 901 and the sequence 902, is greater than a predefined threshold, which in this example may presumed to be 0.85, new ML tasks may be discovered. For example, when the performance of the sequence with ML models M2 and M3, where ML model M2 is used in generating cell coverage polygons and ML model M3 is used to detect utility poles, is greater than 0.85, a new ML task, task T4 is discovered. The data from ML model M3 (which is trained to detect utility poles) is output from an intermediate representation of the ML model M3. When the intermediate representation of the ML model M3 which includes a representation of street view images to detect utility poles, is used as input to an intermediate representation of ML model M2 (which is trained to generate cell coverage polygons), which already includes a representation of the crowdsourced user equipment UE connection test data, a generalization of the representation of street view images to detect utility poles and the representation of crowdsourced user equipment UE connection test data. This generalization results in obtaining inferences from the data. One such inference may be a new task, T4.

The task T4 enables capacity planning for a site by leveraging a representation of street view images to detect utility poles and a representation of the crowdsourced UE connection test data. The ML task, capacity planning for a site, is not a task on which a separate ML model has been trained. Rather, the ML task T4 is discovered as a result of interaction between intermediate representations of ML models. An interaction between ML models, M2 and M3 causes the ML model M3 to transfer data from its intermediate representation to the intermediate representation of ML model M2.

In another example of discovering new ML tasks, the performance of the sequence with ML models M1 and M2 exceeds the predefined threshold, 0.85, resulting in a new ML task T5 being discovered. In this case, the data from ML model M1 (which is trained on estimating cell-tower location) is output from an intermediate representation of the ML model M1. When the intermediate representation of the ML model M1 which includes a representation of OpenCelliD data to estimate cell-tower location, is used as input to an intermediate representation of ML model M2 (which is trained to generate cell coverage polygons), which already includes a representation of the crowdsourced UE connection test data. Thus, a task, task T5 is discovered, which leverages the intermediate representation input to ML model M2.

The ML task T5 detects coverage holes by leveraging representation of OpenCelliD data to estimate cell-tower location and a representation of the crowdsourced UE connection test data. The ML task, capacity planning for a site, is not a task on which a separate ML model has been trained. Rather, the ML task T4 is discovered as a result of interaction between intermediate representations of ML models, which causes the ML model M2 to transfer data from its intermediate representation to an intermediate representation of ML model M1.

In an exemplary embodiment, a sequence of ML models, M1, M2, and M3, may be trained for ML tasks that have application in Managed Services for Networks (MSN). As illustrated in Table 1, ML models M1, M2, and M3, are Regression machine learning/deep learning (ML/DL) Models, and the datasets D1, D2, and D3, are Key Performance Indicators (KPIs) derived from performance management (PM) counters. Each of the ML models M1, M2, and M3, is trained for ML tasks T1, T2, and T3, respectively. The ML task T1 is a task that detects throughput degradation. The ML task T2 is a task that predicts latency. The ML task T3 is a task that predicts Physical Resource Block (PRB) utilization. Based on ML tasks T1, T2, and T3, the method 300 using sequences between ML models, M1, M2, and M3, may reliably execute ML tasks for root cause analysis which includes identifying sources of errors in a network, as shown in Table 2. Additionally, the method 300 discovers new ML tasks using the ML models based on performance of sequences of ML models being greater than a predefined threshold performance. For example, new ML tasks are discovered when performance of sequences between ML models M1, M2, and M3, exceed the predefined threshold performance which for this case, may presumed to be 0.90. The new ML tasks that are discovered include radio capacity planning, which may be derived as a result of interaction between ML models M1, M2, and M3 and the resulting transfer of a representation of KPIs derived from PM Counters (from datasets D1, D2 and D3) across the ML models.

TABLE 1

| Task | Model | Data (e.g.) |
|---|---|---|
| Throughput | Regression ML/DL | KPIs derived from PM |
| Degradation (T₁) | Model (M₁) | Counters (D₁) |
| Latency Prediction | Regression ML/DL | KPIs derived from PM |
| (T₂) | Model (M₂) | Counters (D₂) |
| PRB Utilization | Regression ML/DL | KPIs derived from PM |
| Prediction (T₃) | Model (M₃) | Counters (D₃) |

TABLE 2

| Task | Model Sequence |
|---|---|
| Throughput degradation due to PRB Utilization | M₃ → M₁ |
| Latency degradation due to PRB Utilization | M₃ → M₂ |
| Throughput-Latency analysis | M₂ → M₁ |

Advantageously, the method 300 disclosed herein may facilitate a pool of ML models to be used effectively for identifying new ML tasks based on performance of ML models and sequences of ML models. The method 300 provides for calculating performance of ML models using an update rule that penalizes decrease in performance of a sequence while rewarding increase in performance of the sequence.

It will be appreciated that the method 300 may comprise additional, alternative, or modified, steps in accordance with what is described throughout this disclosure. An embodiment of the method 300 may be implemented as the computer program 213 comprising instructions which, when the computer program 213 is executed by a processor(s) 211 operative to identify sequences of ML models of a plurality of ML models during a training phase, cause the computing device 200 to carry out the method 300 and become operative in accordance with embodiments of the invention described herein.

The computer program 213 may be stored in a computer-readable data carrier, such as the memory 212.

Alternatively, the computer program 213 may be carried by a data carrier signal, e.g., downloaded to the memory 212 via a wireless-interface circuitry.

The person skilled in the art realizes that the invention by no means is limited to the embodiments described above. On the contrary, many modifications and variations are possible within the scope of the appended claims.

1. A computer-implemented method of identifying sequences of machine learning, ML, models of a plurality of ML models during a training phase, the method comprising:
generating one or more sequences of the ML models;
determining a performance of each sequence of the ML models; and
identifying a sequence with performance greater than a threshold performance.

2. The method of claim 1, further comprising using the sequence with performance greater than the threshold performance in an inference phase.

3. The method of claim 1, wherein a preceding ML model in the sequence outputs data which is used as input to a subsequent ML model in the sequence.

4. The method of claim 3, wherein the data from the preceding ML model in the sequence is output from an intermediate representation of the preceding ML model and is used as input to an intermediate representation of the subsequent ML model in the sequence.

5. The method of claim 1, wherein the sequences of ML models comprise two or more of the plurality of ML models.

6. The method of claim 1, wherein the performance of each sequence of ML models is determined based on respective performances of the ML models in the sequence.

7. The method according to claim 1, wherein each of the plurality of ML models is any one of a neural network, an autoencoder, a generative adversarial network, GAN, model, a long short term memory, LSTM, model, a gated recurrent unit, GRU, a support vector machine, SVM, a decision tree, a random forest, and a deep learning model.

8. A computing device for identifying sequences of machine learning, ML, models of a plurality of ML models during a training phase, the computing device comprising processing circuitry operative to:
generate one or more sequences of the ML models;
determine a performance of each sequence of the ML models; and
identify a sequence with performance greater than a threshold performance.

9. The computing device of claim 8, wherein the processing circuitry further being operative to use the sequence with performance greater than the threshold performance in an inference phase.

10. The computing device of claim 8, wherein a preceding ML model in the sequence outputs data which is used as input to a subsequent ML model in the sequence.

11. The computing device of claim 10, wherein the data from the preceding ML model in the sequence is output from an intermediate representation of the preceding ML model and is used as input to an intermediate representation of the subsequent ML model in the sequence.

12. The computing device of claim 8, wherein the sequences of ML models comprise two or more of the plurality of ML models.

13. The computing device of claim 8, wherein the performance of each sequence of ML models is determined based on respective performances of the ML models in the sequence.

14. The computing device of claim 8, wherein each of the plurality of ML models is any one of a neural network, an autoencoder, a generative adversarial network, GAN, model, a long short term memory, LSTM, model, a gated recurrent unit, GRU, a support vector machine, SVM, a decision tree, a random forest, and a deep learning model.

15. A non-transitory computer readable medium including program code comprising instructions which, when the program code is executed by a computing device comprising processing circuitry, causes the computing device to carry out operations comprising:
generate one or more sequences of the ML models;
determine a performance of each sequence of the ML models; and
identify a sequence with performance greater than a threshold performance.

16.-17. (canceled)

18. The non-transitory computer readable medium of claim 15, wherein the operations further comprise use the sequence with performance greater than the threshold performance in an inference phase.

19. The non-transitory computer readable medium of claim 15, wherein a preceding ML model in the sequence outputs data which is used as input to a subsequent ML model in the sequence.

20. The non-transitory computer readable medium of claim 19, wherein the data from the preceding ML model in the sequence is output from an intermediate representation of the preceding ML model and is used as input to an intermediate representation of the subsequent ML model in the sequence.

21. The non-transitory computer readable medium of claim 15, wherein the sequences of ML models comprise two or more of the plurality of ML models.

22. The non-transitory computer readable medium of claim 15, wherein the performance of each sequence of ML models is determined based on respective performances of the ML models in the sequence.
